(19) United States
(12) Patent Application Publication
(10) Pub. No.: US 2026/0161591 A1
(43) Pub. Date: Jun. 11, 2026

(54) CONTROL CHIP, SYSTEM AND METHOD

(71) Applicant: Nuvoton Technology Corporation, Hsinchu Science Park (TW)

(72) Inventor: Zong-Min LIN, Kaohsiung City (TW)

(21) Appl. No.: 19/389,665

(22) Filed: Nov. 14, 2025

(30) Foreign Application Priority Data
Dec. 10, 2024 (TW) 113147765

(51) Int. Cl. G06F 13/42; G06N 5/04

(52) U.S. Cl. CPC G06F 13/42; G06N 5/04

(57) ABSTRACT

A control chip coupled to an external chip and including an interface control circuit, a first memory, a second memory, and a processing circuit is provided. The interface control circuit outputs data to the external chip according to the transmission setting value. The first memory stores the performance status and the interface setting value. The second memory stores predetermined data. The processing circuit dynamically adjusts the transmission setting value according to the performance status, the interface setting value, and the predetermined data to modify the transmission efficiency.

### CROSS REFERENCE TO RELATED APPLICATIONS

This Application claims priority of Taiwan Patent Application No. 113147765, filed on Dec. 10, 2024, the entirety of which is incorporated by reference herein.

### BACKGROUND OF THE INVENTION

### Field of the Invention

The invention relates to a control chip, and more particularly it relates to a control chip dynamically adjusting the transmission efficiency of an interface control circuit.

### Description of the Related Art

With the advancement of technology, the types and functions of electronic devices are increasing. Most electronic devices have at least one control chip. Since the computing capability of a control chip is limited, the performance of the transmission interface of the control chip is a fixed value. However, when the transmission interface is used in a high-noise environment, the error rate of the data transmitted by the transmission interface will increase.

### BRIEF SUMMARY OF THE INVENTION

In accordance with an embodiment, a control chip is coupled to an external chip and comprises an interface control circuit, a first memory, a second memory, and a processing circuit. The interface control circuit outputs data to the external chip according to the transmission setting value. The first memory stores the performance status and the interface setting value. The second memory stores predetermined data. The processing circuit dynamically adjusts the transmission setting value according to the performance status, the interface setting value, and the predetermined data to modify the transmission efficiency.

In accordance with another embodiment, a control system comprises a first chip and a second chip. The second chip comprises an interface control circuit, a memory, a central processing unit (CPU), and a neural processing circuit. The interface control circuit outputs data to the first chip according to the transmission setting value. The memory stores the performance status and the interface setting value. The CPU enables a trigger signal. The neural processing circuit inputs the performance status and the interface setting value to a neural-network model to generate an inference result in response to the trigger signal being enabled. The memory stores the inference result. The CPU accesses the inference result stored in the memory and adjusts the transmission setting value according to the inference result.

A control method for dynamically adjusting the transmission efficiency between the interface control circuit and an external chip is provided. An exemplary embodiment of the control method is described in the following paragraph. The performance status of the interface control circuit is detected. The performance status and an interface setting value are stored. A neural-network model is utilized to process the performance status and the interface setting value to generate an inference setting value. The inference setting value is utilized to adjust the transmission efficiency between the interface control circuit and the external chip.

The control method may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes an adjustment circuit and a control chip for practicing the disclosed method.

### BRIEF DESCRIPTION OF THE DRAWINGS

The present invention can be more fully understood by reading the subsequent detailed description and examples with references made to the accompanying drawings, wherein:

FIG. 1A is a schematic diagram of an exemplary embodiment of a control system according to various aspects of the present disclosure.

FIG. 1B is a schematic diagram of another exemplary embodiment of the control system according to various aspects of the present disclosure.

FIG. 2 is a schematic diagram of an exemplary embodiment of a control chip according to various aspects of the present disclosure.

FIG. 3 is a flowchart schematic diagram of an exemplary embodiment of a control method according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

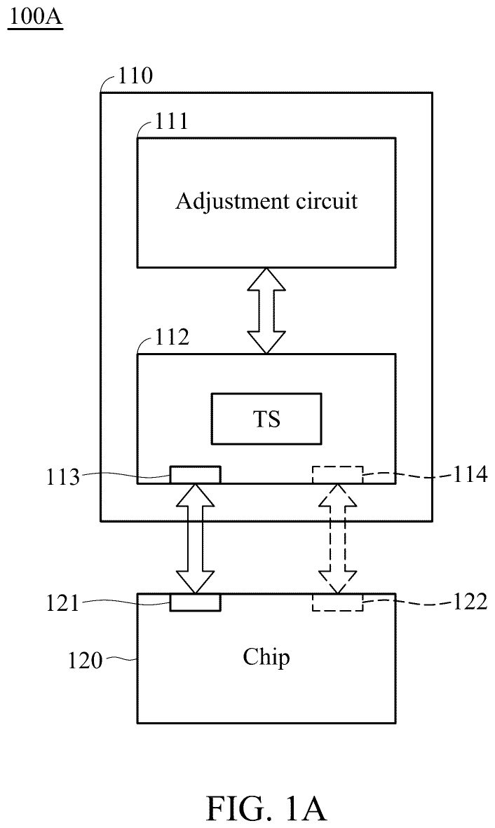

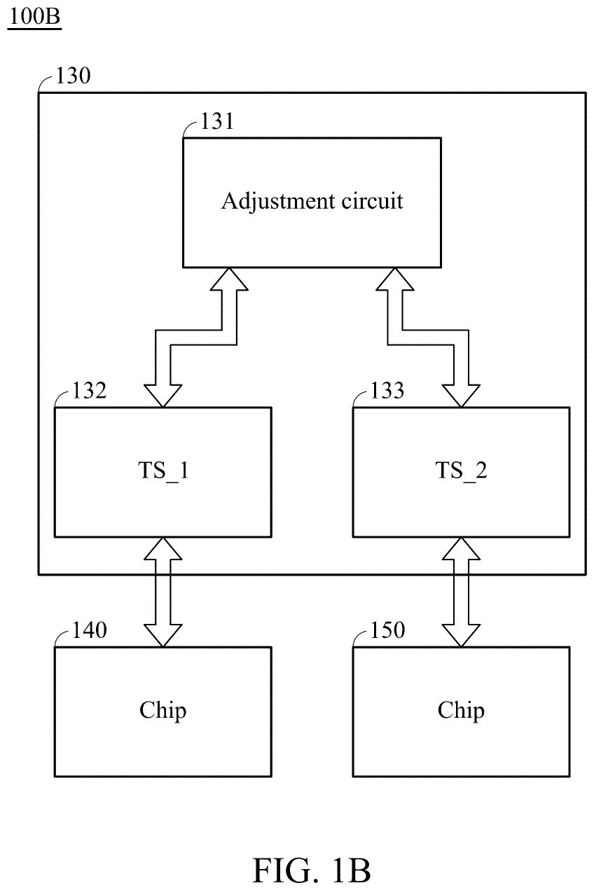

FIG. 1A is a schematic diagram of an exemplary embodiment of a control system according to various aspects of the present disclosure. As shown in FIG. 1A, a control system 100A comprises chips 110 and 120. The types of the chips 110 and 120 are not limited in the present disclosure. In one embodiment, at least one of the chips 110 and 120 is a microcontroller unit (MCU) or a microprocessor unit (MPU). In this embodiment, the chips 110 and 120 are independent of each other. With respect to the chip 110, the chip 120 is an external chip. In one embodiment, the chip 110 is referred to as a control chip.

In this embodiment, the chip 110 comprises an adjustment circuit 111 and an interface control circuit 112. The adjustment circuit 111 determines the application field of the interface control circuit 112 according to the current performance status of the interface control circuit 112, and appropriately adjusts the transmission setting value TS of the interface control circuit 112 according to the determined result, so that the interface control circuit 112 provides the best transmission performance.

For example, when the number of data re-transmissions of the interface control circuit 112 is higher than a threshold value, it indicates that the interface control circuit 112 is applied in an application field with high environmental interference. At this time, the error rate of the data output from the interface control circuit 112 may increase significantly. Therefore, the adjustment circuit 111 may reduce the data transmission rate of the interface control circuit 112. For example, assuming that the operating frequency of the interface control circuit 112 is 100 MHz and the initial data transmission rate of the interface control circuit 112 is 100 MHz. In this case, when the data re-transmission times of the interface control circuit 112 is not higher than a threshold value, the data transmission rate of the interface control circuit 112 is maintained at 100 MHz. However, when the number of data re-transmissions of the interface control circuit 112 is higher than a threshold value, the adjustment circuit 111 reduces the data transmission rate of the interface control circuit 112 from 100 MHz to 50 MHz. At this time, although the data transmission rate of the interface control circuit 112 is reduced to 50 MHz, the operating frequency of the interface control circuit 112 is still maintained at 100 MHz. In another embodiment, when the number of data re-transmissions of the interface control circuit 112 is higher than a threshold value, the adjustment circuit 111 may require the interface control circuit 112 to perform a parity check operation to verify whether the output data is correct. In other embodiments, the adjustment circuit 111 may request the interface control circuit 112 to increase the number of error correction codes (ECC) to reduce the error rate of data.

However, when the number of data re-transmissions of the interface control circuit 112 is lower than a threshold value, it indicates that the interface control circuit 112 is applied in an application field with low environmental interference. At this time, the adjustment circuit 111 improves the transmission efficiency of the interface control circuit 112. For example, the adjustment circuit 111 increases the data transmission rate of the interface control circuit 112 from 50 MHz to 100 MHz. In other embodiments, the adjustment circuit 111 requests the interface control circuit 112 to reduce the amount of redundant data (e.g., to reduce the amount of ECC), or to increase the clock frequency of the interface control circuit 112.

The present disclosure does not limit how the adjustment circuit 111 detects the application field of the interface control circuit 112. In one embodiment, the adjustment circuit 111 uses a lookup table (LUT) or a neural-network model to determine the application field of the interface control circuit 112. The adjustment circuit 111 adjusts the transmission setting value TS of the interface control circuit 112 according to the application field of the interface control circuit 112, so that the interface control circuit 112 provides the best transmission efficiency.

The interface control circuit 112 outputs data to the chip 120 or receives data from the chip 120 according to the transmission setting value TS. In some embodiments, the chip 110 further comprises a control circuit (not shown). In this case, the interface control circuit 112 outputs data from the control circuit to the chip 120 or provides data from the chip 120 to the control circuit. The structure of the interface control circuit 112 is not limited in the present disclosure. In one embodiment, the interface control circuit 112 comprises at least one of a Universal Asynchronous Receiver Transmitter (UART), a Serial Peripheral Interface (SPI), an Inter-Integrated Circuit (I2C), an Improved Inter Integrated Circuit (I3C), and a Controller Area Network (CAN).

In this embodiment, the interface control circuit 112 comprises an interface 113. The interface 113 is coupled to the interface 121 of the chip 120. The type of the interface 113 is the same as the type of the interface 121. For example, interfaces 113 and 121 are serial peripheral interfaces. In other embodiments, the interface control circuit 112 further includes an interface 114. The interfaces 114 and 113 may be coupled to different chips, or may be coupled to different interfaces of the same chip. In one embodiment, the interface 114 is coupled to an interface 122 of the chip 120. In this case, the type of the interface 114 may be different from the type of the interface 113. For example, the interface 113 is a SPI and the interface 114 is an UART interface.

FIG. 1B is a schematic diagram of another exemplary embodiment of the control system according to various aspects of the present disclosure. The control system 100B comprises chips 130, 140, and 150. In one embodiment, at least one of the chips 130, 140, and 150 is a MCU or a MPU. In this embodiment, the chip 130 comprises an adjustment circuit 131, and interface control circuits 132 and 133. The adjustment circuit 131 determines the application fields of the interface control circuits 132 and 133 according to the performance statuses of the interface control circuits 132 and 133, and appropriately adjusts the transmission setting value TS_1 of the interface control circuit 132 and the transmission setting value TS_2 of the interface control circuit 133 according to the determined result. Since the feature of the adjustment circuit 131 is similar to the feature of the adjustment circuit 111, the description of the feature of the adjustment circuit 131 is omitted.

The interface control circuit 132 outputs data to the chip 140 or receives data from the chip 140 according to the transmission setting value TS_1. The interface control circuit 133 outputs data to the chip 150 or receives data from the chip 150 according to the transmission setting value TS_2. Since the features of the interface control circuits 133 and 133 are similar to the feature of the interface control circuit 112, the descriptions of the features of the interface control circuits 132 and 133 are omitted.

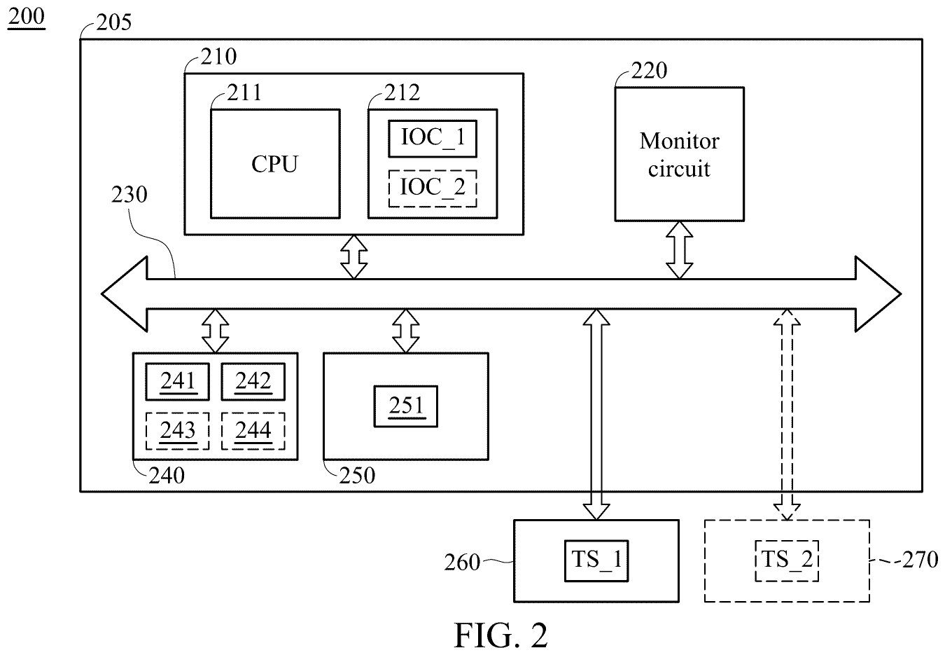

FIG. 2 is a schematic diagram of an exemplary embodiment of a control chip according to various aspects of the present disclosure. The control chip 200 comprises an adjustment circuit 205 and a interface control circuit 260. The interface control circuit 260 outputs data to an external chip (not shown) according to the transmission setting value TS_1. Since the feature of the interface control circuit 260 is similar to the feature of the interface control circuit 112 of FIG. 1A, the description of the feature of the interface control circuit 260 is omitted.

The adjustment circuit 205 comprises a processing circuit 210, a monitor circuit 220 and a memory 240. The monitor circuit 220 monitors the performance status of the interface control circuit 260 to generate a performance status 241. In one embodiment, the monitor circuit 220 monitors at least one of the transmission throughput (MB/s), the number of data re-transmissions, the number of error bits, the attenuation level of the signal strength (such as the peak voltage at the receiving end), the propagation delay time, the turnaround time and the signal-to-noise ratio of the interface control circuit 260 during the current transmission process.

The structure of the monitor circuit 220 is not limited in the present disclosure. In one embodiment, the monitor circuit 220 is a processor, such as a Central Processing Unit (CPU). The monitor circuit 220 executes a monitoring software program to monitor the performance status of the interface control circuit 260. For example, while the interface control circuit 260 outputs data to an external device, the monitor circuit 220 activates a counter (not shown). When the interface control circuit 260 receives a response signal (ACK), the monitor circuit 220 de-activates the counter. The monitor circuit 220 calculates a propagation delay time according to the count value of the counter. In this case, the monitor circuit 220 uses the propagation delay time as the performance status 241.

In another embodiment, when the interface control circuit 260 sends a request to an external device, the monitoring circuit 220 activates a counter (not shown). After the external device completes a specific operation according to the request, the external device generates a response signal to the interface control circuit 260. When the interface control circuit 260 receives the response signal from the external device, the monitor circuit 220 de-activates the counter. The monitor circuit 220 calculates a turnaround time according to the count value of the counter. In this case, the monitor circuit 220 uses the turnaround time as the performance status 241.

In some embodiments, the monitor circuit 220 executes a monitoring software program to determine the attenuation level of the signal strength between the interface control circuit 260 and an external chip. For example, assuming that the interface control circuit 260 outputs data to an external chip via at least one transmission line. In this case, the monitor circuit 220 executes the monitoring software program to issue a command to request the interface control circuit 260 to reply the actual voltage level (e.g., 0.8V) of the transmission line. The monitor circuit 220 obtains the attenuation level, such as 0.2V, of the signal strength between the interface control circuit 260 and the external chip according to the difference between the actual voltage level (such as 0.8V) of the transmission line and a predetermined voltage level (such as 1V). In this case, the monitor circuit 220 uses the attenuation level of the signal strength between the interface control circuit 260 and the external chip as the performance status 241.

In another embodiment, when the interface control circuit 260 outputs data to an external chip via at least one transmission line, the interface control circuit 260 actively replies the signal-to-noise ratio on the transmission line. In some embodiments, the monitor circuit 220 executes a monitoring software program to issue a command to request the interface control circuit 260 to reply the signal-to-noise ratio on the transmission line. In this case, the monitor circuit 220 uses the signal-to-noise ratio on the transmission line between the interface control circuit 260 and the external chip as the performance status 241.

The memory 240 stores the performance status 241. In some embodiments, the memory 240 further stores an interface setting value 242. During an initialization period, the processing circuit 210 accesses the memory 240 to retrieve the interface setting value 242. The processing circuit 210 uses the interface setting value 242 as the transmission setting value TS_1, and provides the transmission setting value TS_1 to the interface control circuit 260.

In one embodiment, the interface setting value 242 (i.e., the transmission setting value TS_1) is related to at least one of the following, such as the number of error correction codes output by the interface control circuit 260, the error detection method used by the interface control circuit 260, the clock frequency of the interface control circuit 260, the size of the output packet of the interface control circuit 260, the driving voltage of the interface control circuit 260, the capacitance of a decoupling capacitor coupled to the interface control circuit 260, and the resistance of a terminal resistor coupled to the interface control circuit 260.

The processing circuit 210 dynamically adjusts the transmission setting value TS_1 according to the performance status 241, the interface setting value 242 and predetermined data 251 to change the transmission efficiency of the interface control circuit 260. In one embodiment, the predetermined data 251 is a table. The table records a plurality of predetermined statuses and a plurality of predetermined setting values. Each predetermined statuses corresponds to a predetermined setting value. The processing circuit 210 determines whether the performance status 241 is the same as a specific status among the predetermined statuses. When the performance status 241 is the same as a specific status of the predetermined data 251, the processing circuit 210 updates the transmission setting value TS_1 according to a specific predetermined setting value corresponding to the specific status.

In other embodiments, the adjustment circuit 205 further comprises an internal connection circuit 230. The internal connection circuit 230 is coupled to the processing circuit 210, the monitor circuit 220, the memory 240 and the interface control circuit 260. The internal connection circuit 230 is responsible for the communication between the processing circuit 210, the monitor circuit 220, the memory 240 and the interface control circuit 260.

For example, the processing circuit 210 accesses the memory 240 or adjusts the transmission setting value TS_1 of the interface control circuit 260 via the internal connection circuit 230. The structure of the internal connection circuit 230 is not limited in the present disclosure. In one embodiment, the internal connection circuit 230 includes at least one of an Advanced eXtensible Interface (AXI), an Advanced High-performance Bus (AHB), and an Advanced Peripheral Bus (APB).

In some embodiments, the adjustment circuit 205 further comprises a memory 250. The memory 250 stores the predetermined data 251. The types of the memories 240 and 250 are not limited in the present disclosure. In one embodiment, the memory 240 is a volatile memory, such as RAM. In another embodiment, the memory 250 is a non-volatile memory, such as a flash. In some embodiments, the processing circuit 210 may load the predetermined data 251 of the memory 250 into the memory 240.

The structure of the processing circuit 210 is not limited in the present disclosure. In one embodiment, the processing circuit 210 comprises a CPU 211 and a neural processing circuit (NPU) 212. The CPU 211 generates a trigger signal. The NPU 212 receives the trigger signal via the internal connection circuit 230. When the CPU 211 enables the trigger signal, the NPU 212 performs an inference operation. In one embodiment, the NPU 212 accesses the memory 250 via the internal connection circuit 230 to retrieve the predetermined data 251. In this case, the predetermined data 251 is a neural network model. During the inference operation, the NPU 212 accesses the memory 240 via the internal connection circuit 230 to retrieve the performance status 241 and the interface setting value 242. After completing the inference operation, the NPU 212 generates an inference setting value IOC_1.

In one embodiment, the predetermined data 251 may have a pre-trained model structure, such as a neural network model. In one embodiment, the neural network model has at least one fully-connected layer. In some embodiments, the predetermined data 251 further has a plurality of model parameters (weight/bias).

The NPU 212 inputs the performance status 241 and the interface setting value 242 into the predetermined data 251. The predetermined data 251 computes the performance status 241 and the interface setting value 242 to generate an inference setting value IOC_1. In one embodiment, the NPU 212 provides the inference setting value IOC_1 to the interface control circuit 260 via the internal connection circuit 230. In this case, the interface control circuit 260 updates the transmission setting value TS_1 according to the inference setting value IOC_1, and outputs data to the external chip according to the updated transmission setting value TS_1. In another embodiment, the NPU 212 writes the inference setting value IOC_1 into the memory 240 via the internal connection circuit 230. In this case, the CPU 211 retrieves the inference setting value IOC_1 from the memory 240 via the internal connection circuit 230, and then adjusts the transmission setting value TS_1 according to the inference setting value IOC_1.

In some embodiments, the control chip 200 further comprises an interface control circuit 270. The adjustment circuit 205 adjusts the transmission setting value TS_2 of the interface control circuit 270 to adjust the transmission efficiency of the interface control circuit 270. In this case, the monitor circuit 220 monitors the performance status of the interface control circuit 270 to generate a performance status 243. The performance status 243 may be stored in memory 240. In this case, the memory 240 further stores an interface setting value 244. During an initialization period, the processing circuit 210 accesses the memory 240 to retrieve the interface setting value 244. The processing circuit 210 uses the interface setting value 244 as the transmission setting value TS_2, and provides the transmission setting value TS_2 to the interface control circuit 270. The interface control circuit 270 outputs data to an external chip according to the transmission setting value TS_2.

In one embodiment, the processing circuit 210 determines whether the performance status 243 is the same as a specific status among the plurality of predetermined statuses recorded in the predetermined data 251. When the performance status 243 is the same as a specific status of the predetermined data 251, the processing circuit 210 updates the transmission setting value TS_2 according to a specific predetermined setting value corresponding to the specific status. In another embodiment, when the CPU 211 triggers the NPU 212, the NPU 212 accesses the memories 240 and 250. The NPU 212 inputs the performance status 243 and the interface setting value 244 to a neural-network model (i.e., the predetermined data 251) to generate an inference setting value IOC_2.

The NPU 212 updates the transmission setting value TS_2 of the interface control circuit 270 according to the inference setting value IOC_2. In another embodiment, the NPU 212 writes the inference setting value IOC_2 to the memory 240. In this case, the CPU 211 updates the transmission setting value TS_2 according to the inference setting value IOC_2 stored in the memory 240.

The structure of the NPU 212 is not limited in the present disclosure. In one embodiment, the NPU 212 comprises at least one of multiple-add (MAC) arithmetic unit and a nonlinear arithmetic unit. In some embodiments, the nonlinear arithmetic unit comprises an activation function, such as a sigmoid function.

In some embodiments, when a predetermined event is occurring, the CPU 211 triggers the NPU 212. The type of the predetermined event is not limited in the present disclosure. In one embodiment, when the count value of a counter (not shown) reaches a target value, it indicates that a predetermined event has occurred. In another embodiment, when the performance status 241 or 243 meets a trigger standard, it indicates that a predetermined event has occurred. Taking the performance status 241 as an example, assuming that the performance status 241 is associated with the number of error bits. When the number of error bits between the interface control circuit 260 and an external chip reaches a threshold value, it means that a predetermined event has occurred. Therefore, the CPU 211 triggers the NPU 212. The NPU 212 performs an inference operation according to the performance status 241, the inference setting value 242 and the predetermined data 251 to generate the inference setting value IOC_1. The CPU 211 or the NPU 212 updates the transmission setting value TS_1 according to the inference setting value IOC_1 to adjust the performance status of the interface control circuit 260. In one embodiment, the interface control circuit 260 increases the number of error bits according to the updated transmission setting value TS_1.

In other embodiments, the CPU 211 executes a monitoring software program to monitor the performance status of the interface control circuit 260. The CPU 211 uses the monitoring result as the performance status 241 and stores the performance status 241 in the memory 240. In this case, the monitor circuit 220 may be omitted. In some embodiments, the monitoring software program may be stored in the memory 240 or 250. In another embodiment, the monitoring software program is stored in a predetermined memory (not shown). The predetermined memory is independent of the memories 240 and 250.

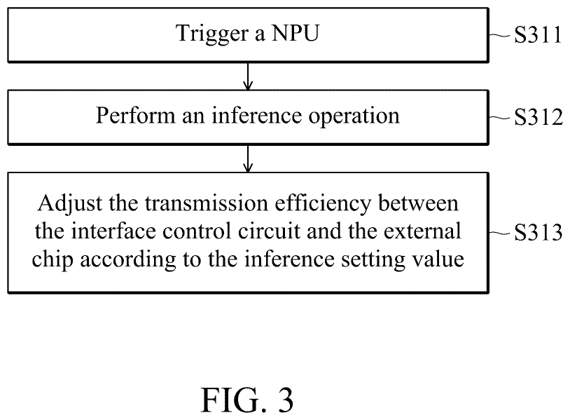

FIG. 3 is a flowchart schematic diagram of an exemplary embodiment of a control method according to various aspects of the present disclosure. The control method dynamically adjusts the transmission efficiency between an interface control circuit and an external chip. The control method may take the form of a program code. When the program code is loaded into and executed by a machine the machine thereby becomes an adjustment circuit and a chip for practicing the method.

First, a NPU is triggered (step S311). In one embodiment, when a predetermined event has occurred, a CPU triggers the NPU. The predetermined event has occurred when the count value of a counter reaches a target value, or the performance status of the interface control circuit meets a trigger standard. In some embodiments, the performance status of the interface control circuit is related to at least one of the following: the transmission throughput, the number of re-transmissions, the number of error bits, the attenuation level of the signal strength, the propagation delay time, the turnaround time, and the signal-to-noise ratio.

Next, the NPU performs an inference operation (step S312). In one embodiment, a monitor circuit monitors the current performance status of an interface control circuit and stores the monitoring result in a first memory. In addition, the interface setting value of the interface control circuit is also stored in the first memory. In some embodiments, the interface setting value is related to at least one of the number of error correction codes output by the interface control circuit, the error detection method used by the interface control circuit, the clock frequency of the interface control circuit, the size of the output packet of the interface control circuit, a driving voltage of the interface control circuit, the capacitance of a decoupling capacitor coupled to the interface control circuit, and the resistance of a terminal resistor coupled to the interface control circuit.

The type of the first memory is not limited in the present disclosure. The first memory may be a volatile memory. In some embodiments, the first memory further stores a neural network model, but the disclosure is not limited thereto. In other embodiments, the neural network model is stored in a second memory. The second memory may be a non-volatile memory. In some embodiments, the neural network model stored in the second memory is loaded into the first memory.

In this embodiment, when a predetermined event is occurring, the NPU accesses the first and second memories to obtain the performance status of the interface control circuit, the interface setting value and the neural network model. The neural network model processes the performance status of the interface control circuit and the interface setting value to generate an inference setting value. In one embodiment, the inference setting value may be stored in the first memory.

The inference setting value is utilized to adjust the transmission efficiency between the interface control circuit and the external chip (step S313). In one embodiment, the CPU or the NPU provides the inference setting value to the interface control circuit to update the interface setting value of the interface control circuit. The interface control circuit communicates with the external chip according to the updated interface setting value.

The control method may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an adjustment circuit and a control chip for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an adjustment circuit and a control chip for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A control chip coupled to an external chip, comprising:
an interface control circuit outputting data to the external chip according to a transmission setting value;
a first memory storing a performance status and an interface setting value;
a second memory storing predetermined data; and
a processing circuit dynamically adjusting the transmission setting value according to the performance status, the interface setting value, and the predetermined data to modify a transmission efficiency.

2. The control chip as claimed in claim 1, wherein:
the predetermined data is a table recording a plurality of predetermined statuses and a plurality of predetermined setting values, and each of the predetermined statuses corresponds one of the predetermined setting values,
in response to the performance status matching a specific status of the predetermined statuses, the processing circuit updates the transmission setting value according to a specific predetermined setting value which corresponds to the specific status.

3. The control chip as claimed in claim 1, wherein:
the predetermined data is a neural-network model,
the neural-network model calculates the performance status and the interface setting value to generate an inference setting value, and
the processing circuit updates the transmission setting value according to the inference setting value.

4. The control chip as claimed in claim 3, wherein the processing circuit comprises:
a neural processing circuit reading the second memory to retrieve the neural-network model and reading the first memory to retrieve the performance status and the interface setting value,
wherein the neural processing circuit inputs the performance status and the interface setting value to the neural-network model.

5. The control chip as claimed in claim 4, wherein the neural processing circuit comprises at least one multiple-add arithmetic unit and a nonlinear arithmetic unit comprising an activation function.

6. The control chip as claimed in claim 4, wherein the neural processing circuit updates the transmission setting value according to the inference setting value.

7. The control chip as claimed in claim 4, wherein the neural processing circuit further comprises:
a central processing unit (CPU) triggering the neural processing circuit in response to an occurrence of a predetermined value,
wherein the CPU updates the transmission setting value according to the inference setting value.

8. The control chip as claimed in claim 7, further comprising:
a counter having a count value,
wherein the neural processing circuit is triggered in response to the count value reaching a target value.

9. The control chip as claimed in claim 7, further comprising:
an internal connection circuit coupled to the CPU, the neural processing circuit, the interface control circuit, the first memory, and the second memory,
wherein the first memory is a volatile memory, and the second memory is a non-volatile memory.

10. The control chip as claimed in claim 9, further comprising:
a monitor circuit monitoring the interface control circuit to generate the performance status.

11. A control method for dynamically adjusting a transmission efficiency between an interface control circuit and an external chip, comprising:
detecting a performance status of the interface control circuit;
storing the performance status and an interface setting value;
utilizing a neural-network model to process the performance status and the interface setting value to generate an inference setting value; and
utilizing the inference setting value to adjust the transmission efficiency between the interface control circuit and the external chip.

12. The control method as claimed in claim 11, further comprising:
determining whether a predetermined event is occurring,
wherein in response to the predetermined event occurring, the neural-network model processes the performance status and the interface setting value.

13. The control method as claimed in claim 12, wherein the step of determining whether the predetermined event is occurring comprises:
determining whether a count value has reached the target value,
wherein in response to the count value reaching the target value, the neural-network model processes the performance status and the interface setting value.

14. The control method as claimed in claim 12, wherein the step of determining whether the predetermined event is occurring comprises:
determining whether the performance status meets a trigger standard,
wherein in response to the performance status meeting the trigger standard, the neural-network model processes the performance status and the interface setting value.

15. The control method as claimed in claim 11, wherein the performance status is related to at least one of the following:
transmission throughput,
number of re-transmissions,
number of error bits,
attenuation level of a signal strength,
propagation delay time,
turnaround time, and
signal-to-noise ratio.

16. The control method as claimed in claim 11, wherein the interface setting value is related to at least one of the following:
number of error correction codes output by the interface control circuit,
error detection method used by the interface control circuit,
clock frequency of the interface control circuit,
size of an output packet of the interface control circuit,
driving voltage of the interface control circuit,
capacitance of a decoupling capacitor coupled to the interface control circuit, and
resistance of a terminal resistor coupled to the interface control circuit.

17. A control system, comprising:
a first chip; and
a second chip comprising:
a first interface control circuit outputting data to the first chip according to a first transmission setting value;
a memory storing a first performance status and a first interface setting value;
a CPU enabling a trigger signal; and
a neural processing circuit inputting the first performance status and the first interface setting value to a neural-network model to generate a first inference result in response to the trigger signal being enabled,
wherein the memory stores the first inference result, and the CPU accesses the first inference result stored in the memory and adjusts the first transmission setting value according to the first inference result.

18. The control system as claimed in claim 17, further comprising:
a second interface control circuit outputting data to a third chip according to a second transmission setting value,
wherein:
the neural processing circuit calculates a second performance status and a second interface setting value according to the neural-network model to generate a second inference result,
the memory stores the second inference result,
the CPU accesses the memory to retrieve the second inference result and adjusts the second transmission setting value according to the second inference result.

19. The control system as claimed in claim 18, further comprising:
a monitor circuit executing a monitoring software program to monitor the performance status of the first interface control circuit and the performance status of the second interface control circuit,
wherein the monitor circuit uses the performance status of the first interface control circuit as the first performance status, and uses the performance status of the second interface control circuit as the second performance status.

20. The control system as claimed in claim 18, wherein the CPU monitors the first interface control circuit to generate the first performance status and monitors the second interface control circuit to generate the second performance status.
